(19) United States
(12) Patent Application Publication
(10) Pub. No.: US 2019/0289173 A1
(43) Pub. Date: Sep. 19, 2019

(54) CAMERA SYSTEM WITH ROTATING ELEMENTS FOR INCREASED FRAMERATES

(71) Applicant: GoPro, Inc., San Mateo, CA (US)

(72) Inventors: Scott Patrick Campbell, Belmont, CA (US); Matthew Stephen Whalen, San Clemente, CA (US)

(21) Appl. No.: 16/298,567

(22) Filed: Mar. 11, 2019

Related U.S. Application Data
(60) Provisional application No. 62/642,431, filed on Mar. 13, 2018.

(51) Int. Cl. H04N 5/225; H04N 5/232

(52) U.S. Cl. CPC H04N 5/2252; H04N 5/2257; H04N 5/2254; H04N 5/23216; H04N 5/232121

(57) ABSTRACT

A camera system includes an array of image sensor assemblies, relay lenses and image processing electronics internal to the camera housing. The image sensor assemblies and relay lenses rotate about the rotation axis such that the image sensor assembly captures light focused into the camera housing by a main imaging lens on an external surface of the camera housing. The camera system is configured to capture images using the lens assemblies and process the images as they are read from the image sensors into a high frame rate video stream. The camera system may be able to configure elements of the camera system to improve the quality of the images used in the video stream.

### CROSS-REFERENCE TO RELATED APPLICATION(S)

This application claims the benefit of U.S. Provisional Patent Application Ser. No. 62/642,431, filed on Mar. 13, 2018. The subject matter of the foregoing is incorporated herein by reference in its entirety.

### TECHNICAL FIELD

This description generally relates to a camera and internal components and more specifically to camera components configured to increase frame rates in camera systems via mechanical rotation of the components.

### BACKGROUND

A high-speed camera is a camera system capable of capturing images at frame rates in excess of 250 frames per second (fps). As high speed video cameras have become more prevalent in today's society the functionality of these cameras is being used for anything from consumer created cat videos to imaging of the earth from satellites. A majority of current high-speed camera technology uses either a charge coupled device (CCD) or CMOS active pixel sensor recording electronic information at high frequencies.

A problem inherent to high-speed camera recording is the need to expose the recording medium (i.e. film, CCD, CMOS etc.) The exposure in high speed cameras requires very bright light to be able to film at the high frame rates and require expensive lighting which may be detrimental to the object being exposed. Further, the sensing elements capable of recording at high frame rates can be prohibitively expensive and hard to manufacture. Currently, no technology uses an array of lower quality camera elements rotating about an axis to achieve higher quality image capture from the array of lower quality elements.

### BRIEF DESCRIPTION OF DRAWINGS

The disclosed embodiments have other advantages and features which will be more readily apparent from the following detailed description of the invention and the appended claims, when taken in conjunction with the accompanying drawings, in which:

FIG. 1 is an isometric view of a camera system with rotating camera array elements, according to one example embodiment.

FIG. 2 illustrates a camera system architecture, according to one example embodiment.

FIG. 3A illustrates a main imaging lens, according to one example embodiment.

FIG. 3B illustrates the internal elements of a rotating camera array, according to one example embodiment.

FIGS. 4A-4E illustrate image sensor assemblies and relay lenses as they rotate towards the capture axis of the camera system, according to one example embodiment.

FIG. 5 illustrates a rotating exposure of an image sensor assembly that rotates through the lens capture range and a relay lens that rotates through the sensor capture range.

FIG. 6 is the process flow for a camera system with rotating elements generating an output video stream, according to one example embodiment.

FIG. 7A illustrates the timing of an image sensor capturing an image, according to one example embodiment.

FIG. 7B illustrates the timing of an image sensor capturing a series of images, according to one example embodiment.

FIG. 8 illustrates a timing diagram of a camera system with rotating elements, according to one example embodiment.

FIG. 9 illustrates a first alternative configuration of a camera system with rotating elements, according to one example embodiment.

FIGS. 10A-10B illustrate a second alternative configuration of a camera system with rotating elements, according to one example embodiment.

FIG. 11A is an optics diagram of a relay lens system, according to one example embodiment.

FIG. 11B illustrates a configuration of the sensors, lenses, and objects in the rotating camera array about the inner support structure and outer support structure, according to one example embodiment.

FIGS. 11C-D illustrate the error in a relayed image as the optical elements, objects, and images in the rotating camera array are perturbed.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

A camera system with rotating elements for the generation of high quality and high frame-rate videos is described. The camera system includes a camera housing with an outer lens assembly coupled to the exterior of the camera housing. The outer lens assembly includes at least one lens element for focusing light into the housing along a capture axis.

Interior the camera housing is a circular inner support structure of an inner radius configured to rotate about a rotation axis at an inner angular velocity. Additionally, interior to the camera housing is a circular outer support structure of an outer radius configured to rotate about a rotation axis at an outer angular velocity. The rotation axis of the inner and outer support structures can be substantially coaxial or dissimilar in various embodiments.

The camera system includes a plurality of image sensor assemblies internal to the camera housing and coupled to the inner support structure configured to capture images from the light focused into the housing. Further the camera system includes a plurality of lens assemblies coupled to the outer support structure configured to focus light into the housing via the outer lens assembly and onto the plurality of image sensor assemblies.

As the image sensors of the plurality of image sensors rotate about the rotation axis on the inner support structure, the image sensors will enter a sensor capture range. The sensor capture range is a first arc of the circle that the inner support structure passes through as it rotates about the rotation axis. As the lens assemblies of the plurality of lens assemblies rotate about the rotation axis on the outer support structure, the lens assemblies will enter a lens capture range. The lens capture range is a n arc of the circle that the outer support structure passes through as it rotates about the rotation axis. The inner and outer support structures are configured to rotate such that as a lens assembly or image sensor exits the lens capture range and sensor capture range, respectively, a new lens assembly or image sensor will rotate into the lens capture range or sensor capture range, respectively.

The system also includes controlling electronics to control the motion of the rotating elements of the camera system. Further embodiments are discussed in more detail below.

### Example Camera Configuration

Traditionally, increasing framerates in a camera system has been accomplished by increasing the rate at which camera electronics are exposed to light, read of the sensor, and interpreted by the processor. As the framerates have increased, the expense of the cameras and the complexity of their manufacture have greatly increased. Described below is a system that can use a combination of lower quality image sensors that capture images at low framerates to create an output video stream with a high framerate.

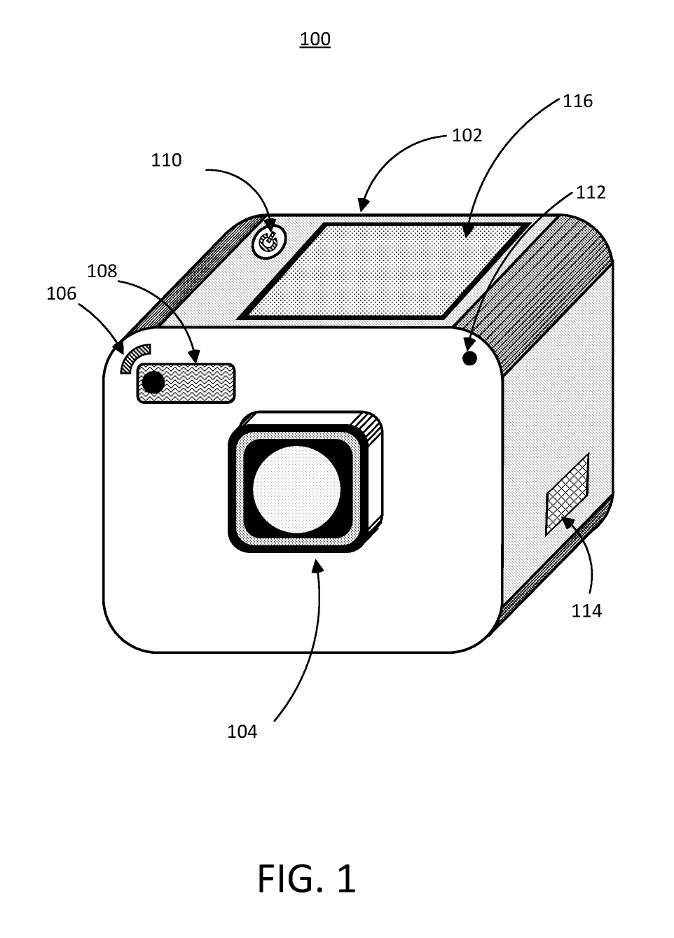

Figure (FIG. 1 illustrates an embodiment of an example camera 100 that may include the components used in a camera system with rotating elements. Additionally, the camera system illustrated in FIG. 1 is intended as an example camera system which can include non-traditional rotating internal camera elements while still including traditional camera functionality. Note that embodiments of the camera discussed hereafter may use any element of the described camera configuration in a substantially different configuration. For example, internal and external components of the camera 100 (e.g. the image sensor and lens elements) may be duplicated and coupled in different configurations.

The camera 100 may comprise a camera housing 102 having a camera lens 104 structured on a front surface of the camera housing, various indicators on the front of the surface of the camera housing 102 (such as LEDs, displays, and the like), various input mechanisms (such as buttons, switches, and touch-screen mechanisms), and electronics (e.g., imaging electronics, power electronics, etc.) internal to the camera housing 102 for capturing images via the camera lens and/or performing other functions. The camera 100 may be configured to capture images and video, and to store captured images and video for subsequent display or playback. In some configurations, the camera may not include a housing.

The camera 100 can include various indicators, including the LED lights 106 and the LED display 108. The camera 100 can also include buttons 110 configured to allow a user of the camera to interact with the camera, to turn the camera on, and to otherwise configure the operating mode of the camera. The camera 100 can also include a microphone 112 configured to receive and record audio signals in conjunction with recording video. The side of the camera 100 may include an I/O interface 114. The camera may also include a loudspeaker (or speaker) system integrated into the camera housing. The camera can include an interactive display 116 that allows for interaction with the camera while simultaneously displaying camera information on a surface of the camera. As illustrated, the camera 100 may include a lens 104 configured to receive light incident upon the lens and to direct received light onto an image sensor internal to the camera housing 102.

### Example System Configuration

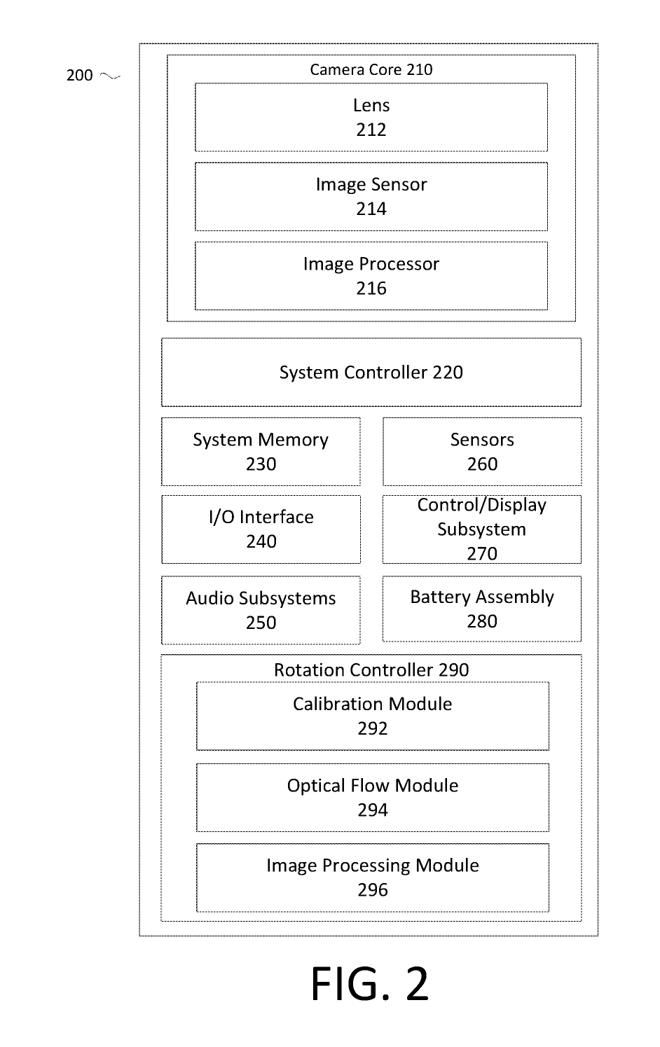

FIG. 2 is a block diagram illustrating a system level example camera architecture 200 corresponding to the rotating camera array. Note that elements (e.g., image sensors, lenses, etc.) of the camera architecture may be duplicated within the rotating camera array. The camera architecture 200 may include rotation control systems 290. The rotation control system may be configured for controlling the rotating elements of the camera array. The camera architecture 200 may also include a camera core 210, a system controller 220, a system memory 230, an I/O interface 240, an audio subsystem 250, sensors 260, a control/display subsystem 270, and a battery assembly 280. The camera core may include a lens 212, an image sensor 214, and an image processor 214.

The components in FIG. 2 are grouped functionally and do not necessarily reflect a physical architecture of the camera architecture 200. For example, as described above, in one embodiment, the control/display subsystem 270 is embodied in a separate physical integrated circuit chip from the image processor 216. The integrated circuit chip including the image processor 216 also may include, for example, the image sensor 212, the system controller 220, system memory 230 and portions of the audio sub-system 250, I/O interface 240, and control/display sub-system 270.

In the example embodiment illustrated in FIG. 2, the camera architecture 200 has a camera core 210 that may include a lens 212, an image sensor 214, and an image processor 216. The camera architecture 200 additionally may include a system controller 220 (e.g., a microcontroller or microprocessor) that controls the operation and functionality of the camera architecture 200. The camera architecture 200 may include system memory 230 configured to store executable computer instructions that, when executed by the system controller 220 and/or the image processors 216, perform the camera functionalities described hereafter. In some example embodiments, a camera architecture 200 may include multiple camera cores 210 to capture fields of view in different directions or in the same direction from several cameras which may then be stitched together to form a cohesive image. For example, in an embodiment of a spherical camera system, the camera architecture 200 may include two camera cores 210 each having a hemispherical or hyper hemispherical lens that each captures a hemispherical or hyper-hemispherical field of view which is stitched together in post-processing to form a spherical image. In other embodiments, multiple camera cores 210 may operate in separate cameras and be integrated via the I/O interface 240. For example, in an embodiment of a camera system with rotating elements, the camera architecture may include at least two camera cores on at least two different cameras connected via the I/O interface 240 whose images are stitched together in post-processing to create a larger camera image or a video segment.

The lens 212 can be, for example, a biconvex lens, a wide angle lens, a hemispherical lens, or a or hyper hemispherical lens (or any other type of lens) that focuses light entering the lens to the image sensor 214 which captures images and/or video frames. The image sensor 214 may capture high-definition video having a resolution of, for example, 480p, 720p, 1080p, 4 k, or any other video resolution. For video, the image sensor 214 may capture video at frame rates of, for example, 30 frames per second, 60 frames per second, or any other possible frame rates. The image processor 216 performs one or more image processing functions of the captured images or video. For example, the image processor 216 may perform a Bayer transformation, de-mosaicing, noise reduction, image sharpening, image stabilization, rolling shutter artifact reduction, color space conversion, compression, or other in-camera processing functions. The image processor 216 may furthermore perform the timing metric calculations. The timing metric calculations may include determining frame rates, shutter speeds, exposure times, battery lifetimes, rate of change of battery lifetimes, time stamping of image, or similar. Processed images and video may be temporarily or persistently stored to system memory 230 and/or to a non-volatile storage, which may be in the form of internal storage or an external memory card. Additionally, the image processor may be configured to capture video or images and not store them in the system memory 230.

An input/output (I/O) interface 240 may transmit and receive data from various external devices. For example, the I/O interface 240 may facilitate the receiving or transmitting video or audio information through an I/O port. Examples of I/O ports or interfaces include USB ports, HDMI ports, Ethernet ports, audio ports, and the like. Furthermore, embodiments of the I/O interface 240 may include wireless ports that can accommodate wireless connections. Examples of wireless ports include Bluetooth, Wireless USB, Near Field Communication (NFC), and the like. The I/O interface 240 may also include an interface to synchronize the camera architecture 200 with other cameras or with other external devices, such as a remote control, a second camera, a smartphone, a client device, or a video server.

Sensors 260 may capture various metadata concurrently with, or separately from, video capture. For example, the sensors 260 may capture time-stamped location information based on a global positioning system (GPS) sensor, and/or an altimeter. Other sensors 260 may be used to detect and capture orientation of the camera architecture 200 including, for example, an orientation sensor, an accelerometer, a gyroscope, or a magnetometer. Additional sensors may be used to detect and capture information about the camera system such as internal or external temperature of camera components such as the camera core, the system controller or the battery assembly. The sensors may additionally detect the presence of liquids within or external to the camera housing or the proximity of liquids to camera components. The sensors may also be configured to monitor the integrity of camera components such as microphones, speakers, membranes, lenses, or any other component of the camera coupled to a sensor. The sensors may also comprise components capable of monitoring position, pressure, time, velocity, acceleration, or similar.

Sensor data captured from the various sensors 260 may be processed to generate other types of metadata. For example, sensor data from the accelerometer may be used to generate motion metadata, comprising velocity and/or acceleration vectors representative of motion of the camera architecture 200. Sensor data from a GPS sensor can provide GPS coordinates identifying the location of the camera architecture 200, and the altimeter can measure the altitude of the camera architecture 200. In one embodiment, the sensors 260 are rigidly coupled to the camera architecture 200 such that any motion, orientation or change in location experienced by the camera architecture 200 is also experienced by the sensors 260. The sensors 260 furthermore may associate a time stamp representing when the data was captured by each sensor. In one embodiment, the sensors 260 automatically begin collecting sensor metadata when the camera architecture 200 begins recording a video. In still other embodiments the sensors may be external to the camera housing and transmit the sensor data or sensor metadata to the camera via the I/O interface 240.

A control/display subsystem 270 includes various control and display components associated with operation of the camera architecture 200 including, for example, LED lights, a display, buttons, microphones, speakers, and the like. The audio subsystem 250 includes, for example, one or more microphones and one or more audio processors to capture and process audio data correlated with video capture. In one embodiment, the audio subsystem 250 includes a microphone array having two or more microphones arranged to obtain directional audio signals.

The battery assembly 280 may include power cells for powering various components of the camera system. For example the power cells may be a Lithium-Ion battery, a Nickel-Cadmium battery, a Nickel-metal-Hydride battery, a Lithium-Polymer battery, a Lead-Acid battery, a solar-cell, a power cord to an external power source, a kinetic power generation system, or any other component used to power an electrical system. The battery assembly may be configured to be controlled by the system controller 220, with the system controller dictating which components of the camera sub-systems and components will receive power during operation. The battery assembly 280 may be controlled by various input mechanisms (such as buttons, switches, and touch-screen mechanisms) on the external body of the camera or by directions received via the I/O interface 160. Additionally, the battery assembly 280 may be removable from the camera system to allow for recharging the power cells of the battery assembly or replacing the current battery assembly 280 with a different battery assembly 280.

The rotation controller may be configured to control, monitor, and adapt movable aspects of the rotating camera array such as: the velocity of the support structures, acceleration of the support structures, movement of the moveable joints, or calibration of any aspect of the rotating camera array.

The rotation controller 290 can include a calibration module 292 configured to calibrate the rotating camera array for image capture. The calibration module 292 can instruct the camera to capture at least one image from all possible combinations of relay lenses and image sensor assemblies. The calibration module may instruct the rotation controller to change the settings of the movable elements of the rotating camera array to improve image and video quality of the output video stream. The calibration module 292 may automatically calibrate the rotating camera array before use or can be instructed to do so by any previously described input method.

The optical flow module 294 may be configured to control the timing of the optical elements of the rotating camera array as they move through the system. This can include electronic control of various elements of the camera system such as: increasing or decreasing exposure times, outputting or inputting various data from the system, increasing or decreasing read times, storing captured frames in the system memory, or interacting with other elements of the camera to improve the functionality of the rotating camera array.

The rotation controller 290 may include an image processing module 296 configured to analyze the images captured by the camera core. The image processing module 296 may be further configured to interpret each image and manipulate the rotating camera array based on the interpretation of the images. For example, the image processing module 296 may use a motion blur detection algorithm to detect image blurring in the images captured by the camera core. The image processing module may instruct the rotation controller to slow the angular velocity (or control some aspect of the camera system) to decrease the motion blur.

### Rotating Camera Array

Generally, the rotating camera array can include a main imaging lens 300 that allows light from external the camera housing to enter internal the camera housing. The main imaging lens 300 can include any number of optical elements (e.g. lenses, gratings, filters, mirrors, prisms, beam splitters, diffusers, etc.) that allows for the light entering the camera housing 100 to be appropriately focused. For example, the main imaging lens 300 can be a single biconvex lens or a series of optically coupled lens(es) and optical elements.

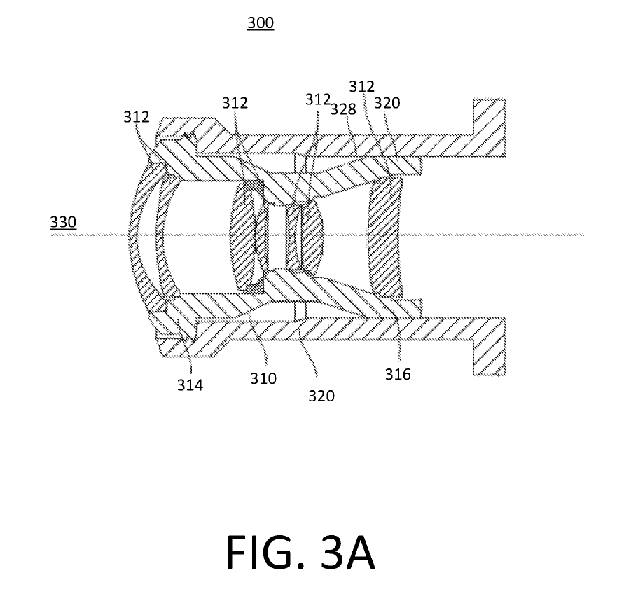

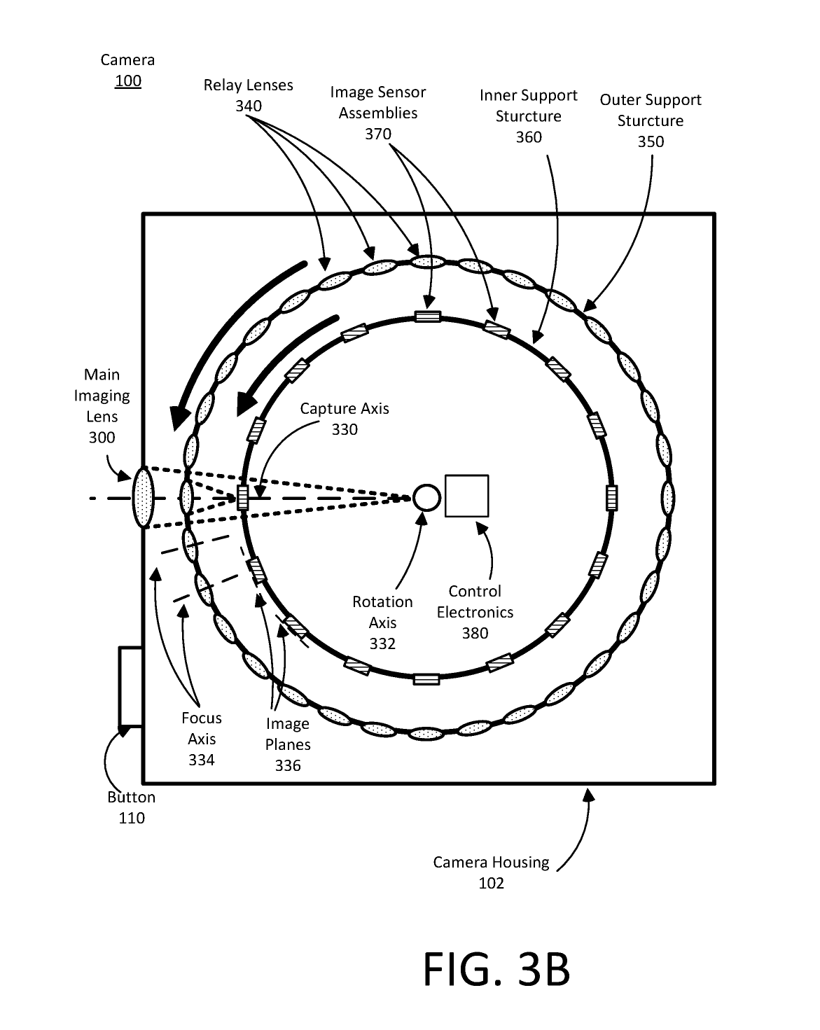

FIG. 3A illustrates a cross-sectional view of an embodiment of an main imaging lens 300 configuration that includes several optical elements for focusing light internal the camera housing. In the illustrated example, the main imaging lens 300 may include a camera lens barrel 310 and a camera lens mount 320. The camera lens mount 320 may be physically affixed to the camera lens barrel 310.

The lens barrel 310 may comprise one or more lens elements or other optical elements 312 (e.g. negative meniscus lenses, biconvex lenses, and a filter) to direct light internal the camera housing 102. The lens barrel 310 might be affixed to the lens mount 320 with a threaded joint at the end of the barrel arms 314. The lens barrel 310 may comprise a lower portion 316, one or more barrel arms 314, and a lens opening (which may be one of the lens elements 312). The lower portion 316 of the lens barrel 310 can be substantially cylindrical and structured to at least partially extend into the channel of the lens tube 322 portion of the camera lens mount 320. The barrel arms 314 may extend radially from the body of the lens barrel 310 and may be outside the channel of the lens mount 320 when assembled. The lens arms 314 may be used to physically couple the lens barrel 310 to the camera body 102 (not shown). The lens opening might include optical components to enable external light to enter the lens barrel 310 and be directed internal the camera housing 102. The camera lens mount 320 may include a tube portion 322 that extends away from the center of the camera housing along the capture axis 330 and may include a substantially cylindrical channel for receiving the lens barrel 310. The back portion of the lens barrel 316 can be used for axial alignment relative to the lens mount 320.

FIG. 3B is an example embodiment of a camera 100 with rotating elements internal to the camera housing 102. The camera housing 102 includes a camera exterior that encompasses and protects the camera's previously described internal electronics. The camera exterior can include six surfaces (i.e. a front face, a left face, a right face, a back face, a top face, and a bottom face), wherein the exterior surfaces form a rectangular cuboid. The camera housing 102 can be made of a rigid material such as plastic, aluminum, stainless steel, or fiberglass. Additional camera features, such as the features described above, may be affixed to an exterior or an interior of the camera. In some embodiments, the camera described herein includes features other than those described above. For example, instead of a single interface button 110, the camera can include additional buttons or different interface features, such as a multiple microphone openings to receive voice or other audio commands. Alternatively or additionally, the camera can include a main imaging lens 300 including a single optical element rather than several optical elements.

The main imaging lens 300 is coupled to the front face of the camera housing, e.g. the left side of the camera 100 in the orientation of FIG. 3. The main imaging lens focuses light form external the camera housing to internal the camera housing along the capture axis 330. Internal to the camera housing 102 can be any number of camera components configured to rotate about a rotation axis 332 including: an outer support structure 350, an inner support structure 360, rotating image sensor assemblies 370, relay lenses 340, and control electronics 380. In the illustrated embodiment of FIG. 3B, the rotation axis 332 may be internal to the camera housing 102 and may be the axis about which the inner support structure 360 and outer support structure 350 rotate. Further, in the context of FIG. 3, the rotation axis is out of the plane of the page.

The relay lenses 340 may be any optical component or combination of optical components configured to focus the light entering the camera housing 102 via the main imaging lens 300 towards the image sensor assemblies 370. The relay lenses 340 may be a similar configuration to the main imaging lens and include similar optical elements. In other embodiments, the optical elements of the relay lenses 340 can be in an alternative configuration. For example, the relay lenses can be a singular lens or any number of optically coupled lenses and optical elements (e.g. lenses, gratings, filters, mirrors, prisms, beam splitters, diffusers, etc.).

The relay lenses 340 are coupled to the outer support structure 350 such that as the outer support structure 350 rotates about the rotation axis 332, the relay lenses 340 are rotated about the rotation axis 332. The relay lenses 340 can be spaced about the outer support structure 350 such that there is an equal distance between each relay lens along the outer support structure 350. In some embodiments, the relay lenses 340 are coupled to the outer support structure 350 with a movable joint such that the focus axis 334 of the relay lenses 340 can be manipulated by actuating the movable joint as the relay lenses rotate about the rotation axis. The movable joint may be able to tilt, rotate, or translate the relay lenses 340 and focus axis 334. The movable joint can be actuated by: motors, actuators, servos, piezo-electronics, pistons, turbines, or any other component that can generate motion of the movable joint. The movable joint may be coupled to and controlled by the control electronics 380 internal to the camera housing 102.

The outer support structure 350 is a substantially circular physical structure configured to rotate about the rotation axis 332 of the camera housing 102. The rotation axis 332 is approximately at the center point of the outer support structure 350. The outer support structure 350 can be made of a rigid material such as plastic, aluminum, stainless steel, or fiberglass and is configured to provide mechanical support to the relay lenses 340. The outer support structure 350 is configured to rotate about the rotation axis 332 at an outer angular velocity. Additionally, the outer support structure 350 may rotate about the rotation axis 332 when actuated by components coupled to the outer support structure 350 and configured to create motion of the outer support structure. The components may be motors, actuators, servos, piezo-electronics, pistons, turbines, or any other component that can generate motion. In some embodiments, the outer support structure is directly coupled to the camera housing 102. In other embodiments the outer support structure 350 is coupled to the camera housing 102 by the actuating components. The outer support structure 350 may be coupled to other components of the camera internal to the camera system. For example, the outer support structure 360 may be coupled to the inner support structure 360 and the inner support structure may be configured with actuators to rotate the outer support structure or elements of the outer support structure.

The inner support structure 360 is a substantially circular physical structure configured to rotate about the rotation axis 332 of the camera housing 102. The rotation axis 332 is approximately at the center point of the inner support structure 360. The inner support structure 360 can be made of a rigid material such as plastic, aluminum, stainless steel, or fiberglass and is configured to provide mechanical support to the image sensor assemblies. The inner support structure 360 is configured to rotate about the rotation axis 332 at an inner angular velocity. Additionally, the inner support structure 360 may rotate about the rotation axis 332 when actuated by components coupled to the outer support structure and configured to create motion of the outer support structure. The components may be motors, actuators, servos, piezo-electronics, pistons, turbines, or any other component that can generate motion. In some embodiments, the inner support structure 360 is directly coupled to the camera housing 102. In other embodiments the inner support structure 360 is coupled to the camera housing by the actuating components. The inner support structure 360 may be coupled to other components of the camera internal to the camera system. For example, the inner support structure 360 may be coupled to the outer support structure 350 and the outer support structure 350 may be configured with actuators to rotate the inner support structure 360.

The image sensor assemblies 370 may comprise a printed circuit board for mounting the image sensor assemblies and may also include various electronic components that operate in conjunction with various components of the camera 100. Each image sensor assembly 370 might house an image sensor (e.g., a high-definition image sensor) for capturing images and/or video and may include structural elements for physically coupling to the image sensor assembly 370. The image sensor assembly 370 is positioned such that image sensor faces away from the rotation axis 332 and may capture light focused into the camera housing by the main imaging lens 300 and relay lenses 340. The image sensor of each image sensor assembly 370 can lie on an image plane 336. In some embodiments, the image sensor assemblies 370 may include additional optical elements to focus light from external the camera housing onto the image plane 336. The combined focal point of the main imaging lens 330 and the relay lenses 370 may be maintained such that the focal point is at the image planes 336 during the rotation of the relay lenses 340 and image sensor assemblies 370.

The image sensor assemblies 370 are coupled to the inner support structure 360 such that as the inner support structure 360 rotates about the rotation axis 332, the image sensor assemblies 370 are rotated about the rotation axis 332. The image sensor assemblies 370 are spaced about the inner support structure 360 such that there is an equal distance between each image sensor assembly along the inner support structure. In some embodiments, the image sensor assemblies 370 are coupled to the inner support structure 360 with a movable joint such that the image plane 336 of the image sensor assemblies can be manipulated by actuating the movable joint as the image sensor assemblies 370 rotate about the rotation axis 332. The movable joint may be able to tilt, rotate, or translate the image sensor and image plane 336. The movable joint can be actuated by: motors, actuators, servos, piezo-electronics, pistons, turbines, or any other component that can generate motion of the movable joint. The movable joint may be coupled to and controlled by the control electronics internal to the camera housing.

The internal electronics assembly 380 may be positioned anywhere within the camera housing 102 and may contain the components of the camera system architecture 200. In some embodiments there may be an internal electronics assembly 380 for each of the image sensor assemblies 370 within the camera 100. The internal electronics assembly 380 may be mounted on a substrate comprising a printed circuit board for mounting electronic components. The internal electronics assembly 380 can include various electronic components that may operate with the image sensor assemblies, the actuators of the inner support structure, the actuators of the outer support structure, or provide external connections to other components of the camera or external electronic devices. The components may include input/output electronics for communicating with external control or storage devices, radio frequency transmitters and receivers for wirelessly communicating with external control or storage devices or other components internal to the camera housing, processing electronics for interpreting and encoding signals, power management electronics for powering onboard components, or similar.

### Lens Assembly and Sensor Assembly Rotation

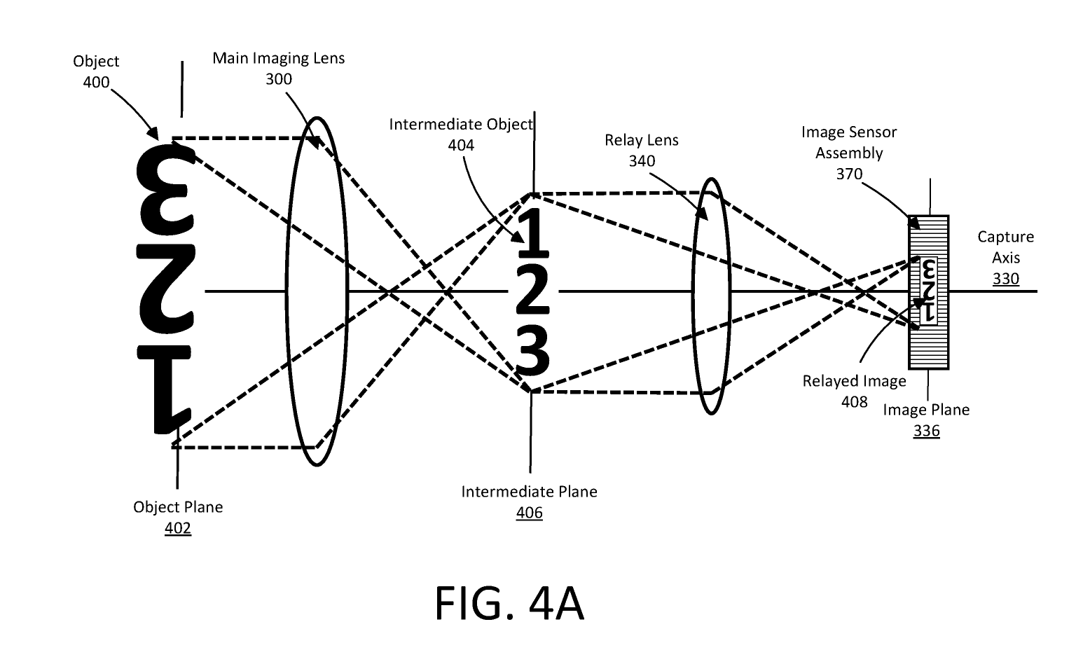

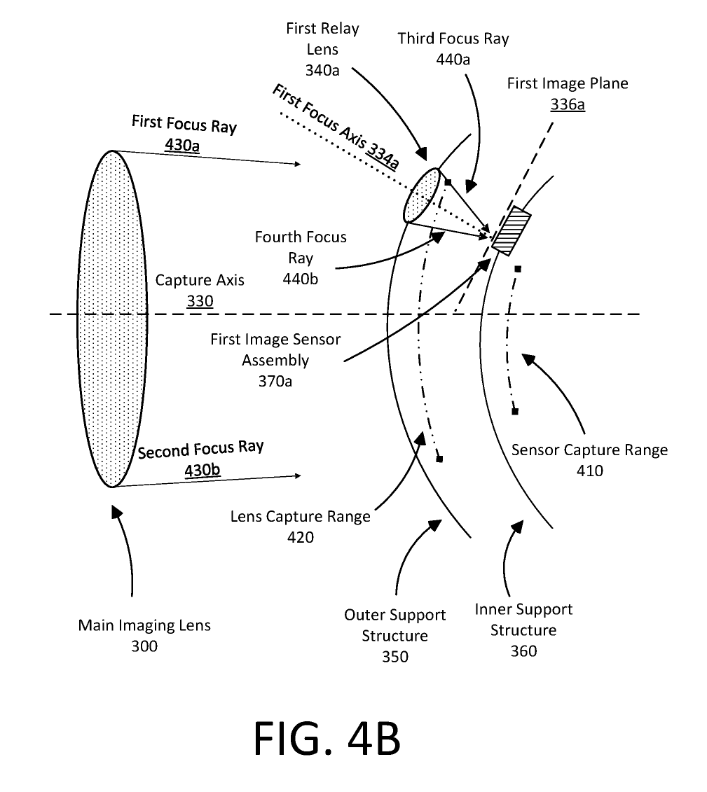

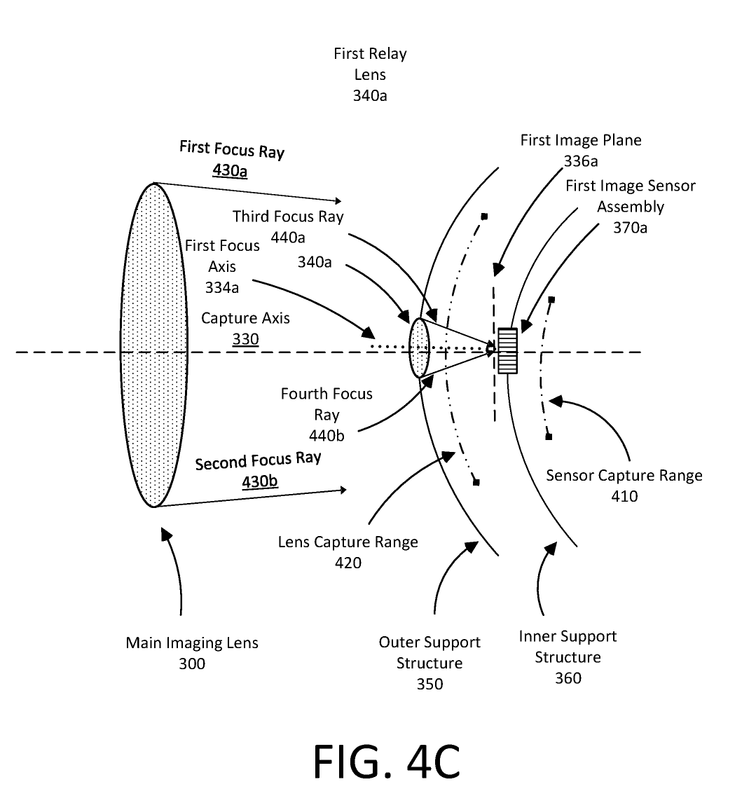

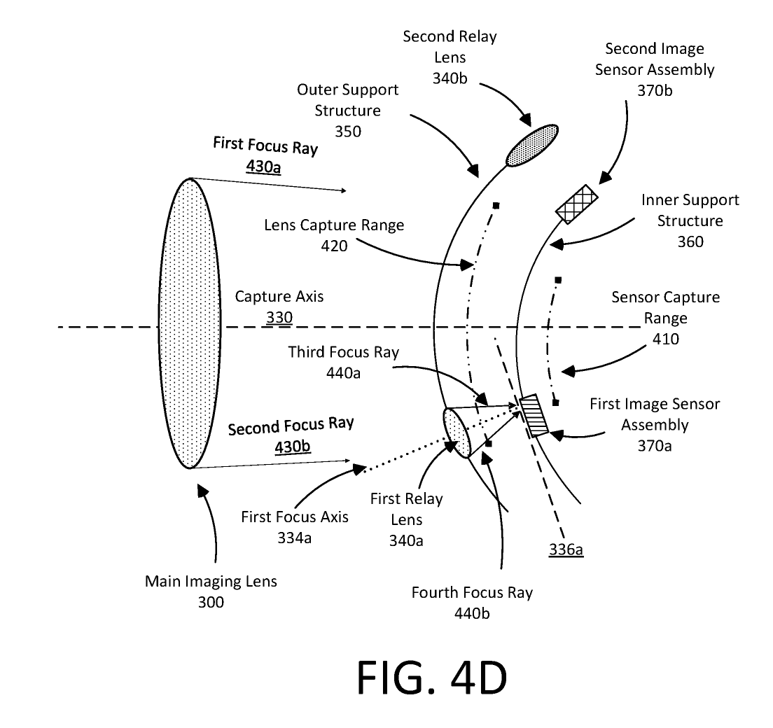

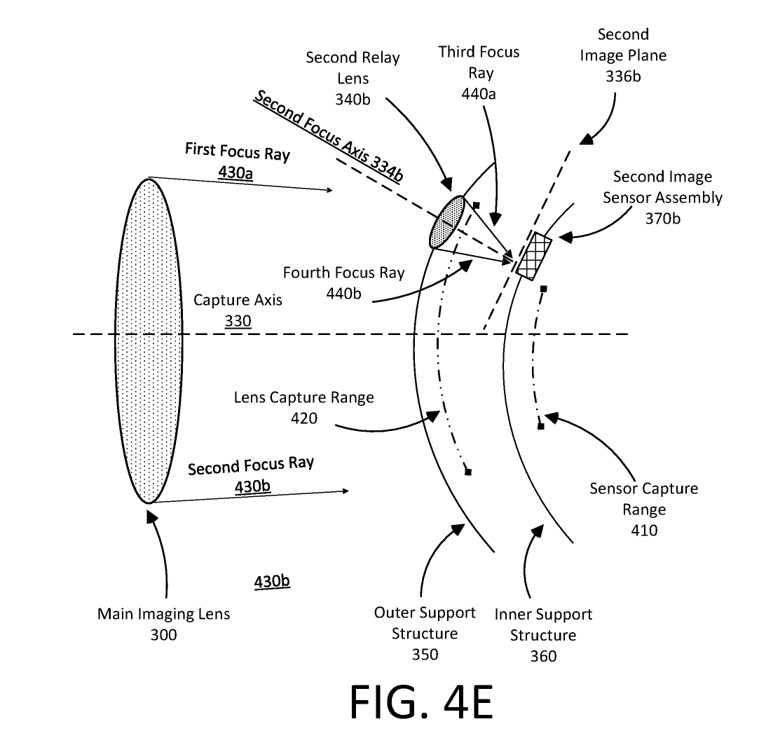

FIG. 4A-4E illustrates how light focused internal the camera housing from external the camera housing by the main imaging lens is further focused by the relay lenses 340 onto the image sensor assemblies 370 as the outer support structure 350 and inner support structure 360 rotate about the rotation axis. Generally, the main imaging lens 300 and relay lenses 340 function as two coupled optical elements that relay an image of an object external the camera body 102 to image sensor assemblies 370 internal the camera body.

FIG. 4A is an illustration of the main imaging lens 300 and the relay lens 340 imaging an object 400 while aligned along the capture axis 330. An object 400 at an object plane 402 is imaged by the main imaging lens 300. The image of the object 400 is translated through the main imaging lens 300 as a virtual object 404 which can be represented on a virtual plane 406. The virtual object is imaged by the relay lens 340. The image of the virtual object 404 is translated through the relay lens 340 as a relayed object 408 which can be represented on the image plane 336. The relay object 408 is captured by the image sensor assembly at the image plane 336. Depending on the optical characteristics (e.g., focal length, numerical aperture, etc.) and optical couplings (e.g., distance between lenses, degree of collimation, etc.) of the main imaging lens 300 and the relay lenses 340, the relayed object 408 imaged by the image sensor assembly can be a modified version of the imaged object 400 (e.g. smaller, translated, rotated, etc.). Desirable optical characteristics and optical couplings are described in the section titled “System Design Considerations.”

Rather than the static illustration of FIG. 4A, in the configurations described herein, relaying the object to the image sensor assembly via the main imaging lens 300 and the relay lens 340 is accomplished using a set of relay lenses 340 and image sensor assemblies 370 that rotate about a rotation axis 332.

The image sensor assemblies 340 rotate through a sensor capture range 410. The sensor capture range 410 is representative of the arc that the inner support structure 360 rotates through in which the image sensor assemblies 340 are configured to capture images from light focused internal the camera housing 102 by the main imaging lens 300 and relay lenses 340.

The relay lenses 340 rotate through a lens capture range 420. The lens capture range 420 is representative of the arc that the outer support structure 350 rotates through in which the relay lenses 340 are configured to further focus light focused internal the camera housing onto the image sensor assemblies 370 as they rotate through the sensor capture range 420.

The process of capturing subsequent images as the relay lenses 340 and image sensor assemblies 370 rotate about the rotation axis 332 is described in FIGS. 4B-4E.

Beginning with FIG. 4B, the main imaging lens 300 focuses light into the camera housing (illustrated as the first focus ray 430a and the second focus ray 430b) along the capture axis 330. As the outer support structure 350 rotates, a first relay lens 340a of the relay lenses coupled to the outer support structure 350 enters the lens capture range 420. As the inner support structure 360 rotates, a first image sensor assembly 370a of the image sensor assemblies coupled to the inner support structure 360 enters the sensor capture range 410. The first relay lens 340a further focuses the light entering the housing 102 (illustrated by the third focus ray 440a and the fourth focus ray 440b) towards the first image sensor assembly 370a and a first image plane 336a along a first focus axis 334a.

In FIG. 4C the outer support structure 350 and the inner support structure 360 have continued to rotate about the rotation axis through the sensor 410 and the lens 420 capture ranges. Being coupled to outer support structure and inner support structure, respectively, the first relay lens 340a and the first image sensor assembly 370a have also rotated about the rotation axis through the sensor 410 and lens 420 capture ranges. As the first relay lens 340a rotates about the rotation axis and through the lens capture range 410, the first relay lens 340a continues to further focus the light towards the first image sensor assembly 370a and first image plane 336a along the first focus axis 334a.

In FIG. 4D the outer support structure 350 and the inner support structure 360 have continued to rotate about the rotation axis through the sensor 410 and the lens 420 capture ranges. Being coupled to outer support structure 350 and inner support structure 360, respectively, the first relay lens 340a and the first image sensor assembly 370a have also rotated about the rotation axis and are now nearing the end of the sensor 410 and lens 420 capture ranges. A second relay lens 340b and a second image sensor assembly 370b approach the sensor 410 and the lens 420 capture ranges as the outer support structure 350 and inner support structure 360 rotate about the rotation axis. As the first relay lens 340a rotates about the rotation axis, the lens elements continue to further focus the light towards the first image sensor assembly 370a and first image plane 336a along the first focus axis 334a.

In FIG. 4E the outer support 350 structure and the inner support structure 360 have continued to rotate about the rotation axis through the sensor 410 and the lens 420 capture ranges. Being coupled to outer support structure 350 and inner support structure 360, respectively, the first relay lens 340a and the first image sensor assembly 370a have also rotated about the rotation axis and have exited the sensor 410 and lens 420 capture ranges. The second relay lens 340b and the second image sensor assembly 370b enter the sensor 410 and the lens 420 capture ranges as the first relay lens 340a and first image sensor assembly 370a rotate out of the sensor 410 and the lens 420 capture ranges about the rotation axis. The second lens assembly 340b further focuses the light entering the housing 102 towards the second image sensor assembly 370b and second image plane 336b along a second focus axis 334b.

The process of image sensor assemblies 370 and relay lenses 340 rotating into and out of the sensor 410 and the lens 420 capture ranges continues as the inner support structure 350 and the outer support structure 360 rotate about the rotation axis. In some embodiments the relay lenses 340 and the image sensor assemblies 370 may move about their respective movable joints to aid in better focusing light onto the image sensors.

### Rolling Exposures

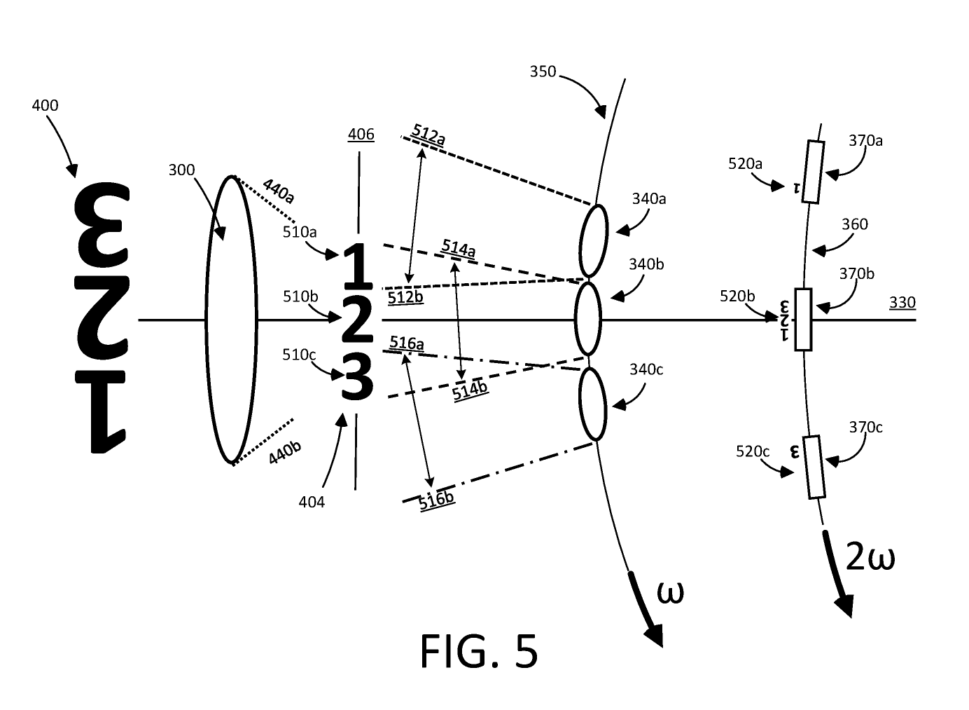

FIG. 5 illustrates how an image is captured by an image sensor assembly 370 as the relay lens 340 rotates through the lens capture range and the image sensor assembly rotates through the sensor capture range 420 (the lens capture range, sensor capture range, inner support structure, and outer support structure are not shown for clarity), according to one example embodiment. The illustrated relay lenses 340a-c are the same relay lens 340 illustrated in three positions as the relay lens 340 rotates about the outer support structure 350. The illustrated image sensor assemblies 370a-c are the same image sensor assembly 370 illustrated in three positions as the image sensor assembly rotates about the inner support structure 360.

The light representing an object 400 is focused into the camera housing by the main imaging lens 300. For illustrative purposes, the light of the object 500 is contained between the first focus ray 440a and the second focus ray 440b. The image of the object 400 can be divided into three portions 510a, 510b, and 510c. The image of the object 400 can be the intermediate object 404 (and portions 510a-510c of the intermediate object 404) for the relay lens 340.

To begin, a relay lens 340 has entered the lens capture range and an image sensor assembly 370 has entered the sensor capture range. When the relay lens first enters the lens capture range it is at a first lens position (illustrated as 340a). When the image sensor assembly enters the sensor capture range it is at a first sensor position (illustrated as 370a). At this first lens position, the relay lens 340a has a first field of view 512a-b. The first field of view 512a-b captures a first portion 510a of the intermediate object 404. The first portion 510a of intermediate object 404 is imaged by the relay lens 340a at the first sensor position. The image of the first portion 510a of the intermediate object 404 is relayed onto a first portion 520a of the image sensor assembly 370 and captured by the image sensor as the relayed image.

To continue, after an amount of time, the relay lens 340 has rotated through a portion of the lens capture range and an image sensor assembly 370 has rotated through a portion of the sensor capture range. At this point, the relay lens is aligned with the captures axis 330 at a second lens position (illustrated as 340b). Additionally, at this point, the image sensor assembly 370 is aligned with the capture axis 330 and a second sensor position (illustrated as 370b). At this second lens position, the relay lens 340b has a second field of view 514a-b. The second field of view 514a-b captures all portions 510a-c of the intermediate object 404. The portions 510a-c of intermediate object 404 are imaged by the relay lens 340b. The image of all the portions 510a-c of the intermediate object 404 is relayed onto a second portion 520a of the image sensor assembly 370 and captured by the image sensor as the relayed image.

To continue, after an additional amount of time, the relay lens 340 has rotated through most of the lens capture range and the image sensor assembly 370 has rotated through most of the sensor capture range. At this point, the relay lens 340 is about to leave the lens capture range and is at a third lens position (illustrated as 340c). The image sensor assembly 370 is about to leave the sensor capture range it is at a third sensor position (illustrated as 370c). At this third lens position, the relay lens 340c has a third field of view 516a-b. The third field of view 516a-b captures the third portion 510c of the intermediate object 404. The third portion 510c of intermediate object 404 is imaged by the relay lens 340c. The image of the third portion 510c of the intermediate object is relayed onto a third portion 520c of the image sensor assembly 370 and captured by the image sensor as the relayed image.

The camera 100 is configured such that as the relay lens 340 and the image sensor assembly 370 rotates through the sensor and the lens capture ranges the entirety of the light representing the object 500 is focused onto the image sensor assembly 370. Generally, the image sensor assemblies rotate at twice the angular velocity as the relay lenses. While the demonstrative images show three portions of the object 400 being focused on the image sensor assembly 370, the light is focused onto the image sensor in a continuous process as the image sensor assemblies 370 and the relay lenses 340 rotate through the sensor and lens capture ranges. In some embodiments, the movable joints coupling the relay lenses and the image sensor assemblies to their respective support structures can be actuated to manipulate the focus axis and image plane. The manipulation of the focus axis and image plane may increase the performance of the camera system by improving the quality of the captured images (i.e. less image blur, better registration between subsequent images, less image distortion etc.).

In other additional embodiments, the object may be imaged from the bottom of the image sensor assembly 370 to the top of the image sensor assembly 370 as the image sensor assembly and relay lens rotate through the sensor capture range and the lens capture range about the rotation axis.

Additional details regarding the rolling shutter and exposure system for use in a camera system are described in U.S. Pat. No. 9,204,041, granted Dec. 1, 2015, which is hereby incorporated by reference in its entirety.

### Output Video Generation

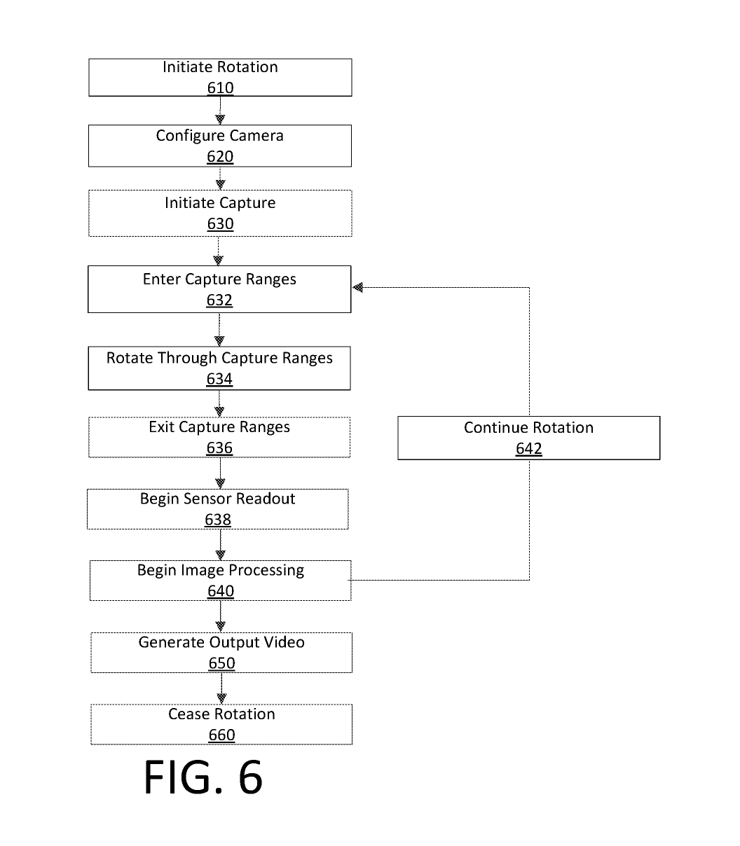

FIG. 6 is the process flow the camera 100 takes when capturing images, according to one embodiment. To begin, the camera initiates 610 rotation of the inner support structure and outer support structure. The inner support structure is accelerated to an inner angular velocity and the outer support structure is accelerated to an outer angular velocity. In some embodiments, the inner angular velocity is twice the outer angular velocity.

The system may configure 620 the camera to improve image capture and processing. Configuring the camera may include taking images for every combination of image sensor assemblies and relay lenses and compensating for errors in the captured images. Compensating for errors can include: configuring the movable joints of the relay lenses to change the focus axes for each pair of image sensor assembly and relay lens, configuring the movable joints of the image sensor assemblies to change the image plane for each pair of image sensor assembly and relay lens, configuring the inner angular velocity, configuring the outer angular velocity, manipulating captured images during image processing based on the images captured during camera configuration, applying filters to captured images during image processing based on images captured during camera configuration, or any other similar process that can improve the quality of images captured by the camera system.

After configuring the camera system, the camera system initiates 630 image capture using the rotating camera elements. A first image sensor of the image sensor assemblies and a first relay lens of the set of relay lenses enter 632 the sensor and lens capture ranges as the inner support structure and outer support structure rotate, respectively. The first image sensor and the first relay lens rotate 634 through the sensor and lens capture ranges capturing an image. The first image sensor and the first relay lens exit 636 the capture ranges and begin 638 the sensor readout of the captured image. After the sensor readout is concluded, the camera system begins 640 image processing of the captured image. In some configurations, the camera system can begin 640 image processing at any point after the camera system begins 638 the sensor readout.

Image processing can be any manipulation of the image after capturing including: applying a filter to the image, generating a video frame, storing the image, manipulating the data of the image, adding metadata to the image, translating the image, rotating the image, or any other image manipulation technique. The inner and outer support structures continue 642 to rotate and a second image sensor of the image sensor assemblies and a second relay lens of the relay lenses enter 632 the sensor and lens capture ranges.

After images have been captured and processed by the camera system, the system may generate 650 output video by stitching together the captured images. Generating the output video can be accomplished at any point after at least two frames have been captured. In some embodiments, generating output video may happen in conjunction with capturing images. Once the camera has completed capturing images for the output video, the camera system ceases 660 rotation by decelerating the inner and outer support structures via the actuators coupled to the support structures. In some embodiments, decelerating the inner outer support structures may occur without actuation.

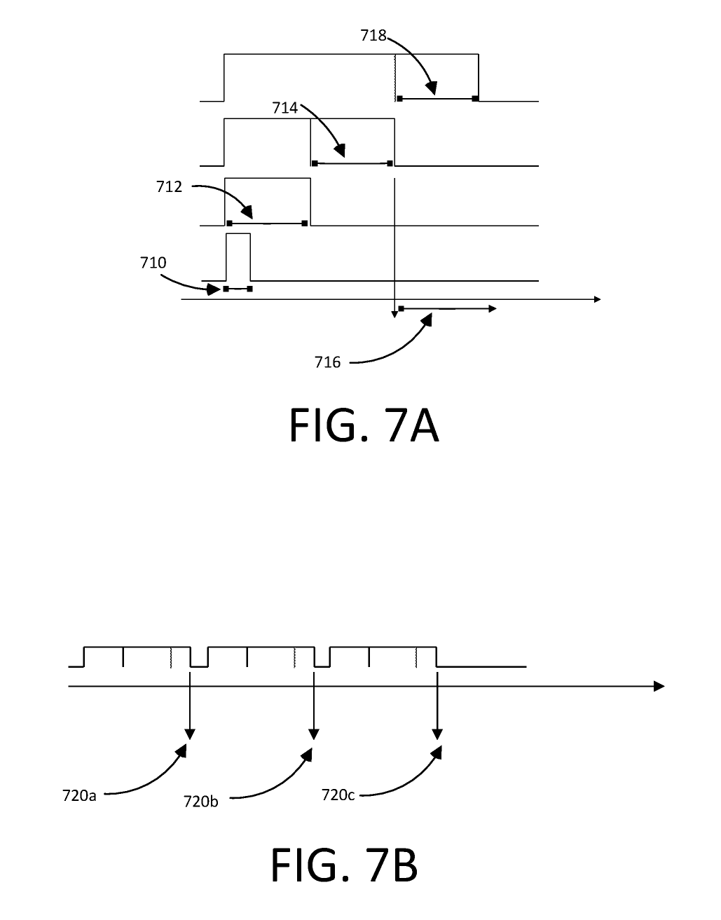

FIGS. 7A-7B illustrate example timing diagrams for image capture of various camera systems, according to one embodiment. Time is represented by the x axis, with activity of an image sensor represented by lines on they axis. When the image sensor is inactive, the line of the image sensor is ‘low,’ and when the image sensor is active, the line of the image sensor is ‘high.’

FIG. 7A illustrates a timing diagram for one image sensor of the image sensor assemblies. During capture, an image sensor of the image sensor assembly uses a first exposure time 710 to capture light during a first exposure. In the capture process of the rotating camera array, as the image sensor rotates through the sensor capture range light is focused on to different areas of the image plane. This ‘rolling exposure’ uses a second exposure time 712 to capture light during the entire exposure. After the exposure of the image sensor during the rolling exposure, reading the captured image from the image sensor requires a first read time 714. Once the image has been read from the sensor, an output frame 716 can be generated by the image processor of the camera architecture. After the image has been read from the image sensor, a first amount of refresh time 718 is required to refresh the image sensor assembly before capturing a second image.

FIG. 7B illustrates a single image sensor in a camera system repeatedly exposing, reading, and refreshing an image sensor to generate output frames 720a-720c for an output video in which the output frames are generated after the image sensor has been refreshed. Note than in some embodiments, the output frame can be generated at any time after the reading of each image off the image sensor. The continuous generation of output frames from a single camera yields a first frame rate.

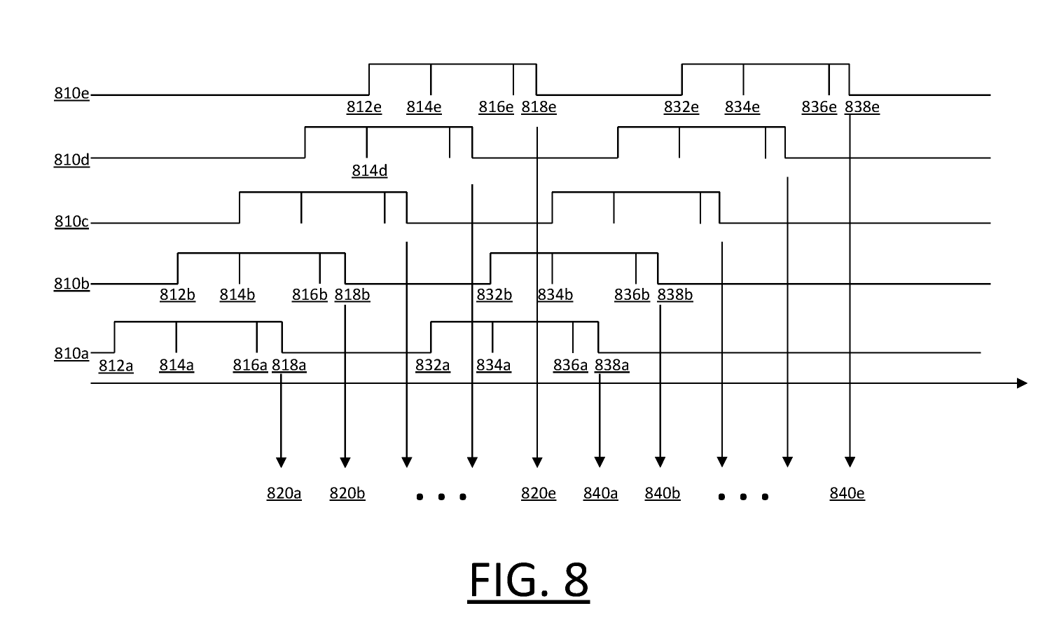

FIG. 8 illustrates a timing diagram for a rotating camera array with five image sensor assemblies 810a-810e. Time is represented by the x axis, with each image sensor having an independent line on they axis. When the image sensors is inactive, the line of that image sensor is low,′ and when the image sensor is active, the line of that image sensor is ‘high.’

When a first image sensor assembly rotates into the sensor capture range the image sensor assembly begins exposing 812a the image sensor 810a. As the first image sensor assembly rotates through the sensor capture range, the image sensor is continuously exposed (e.g. rolling exposure). After the first image sensor 810a exits 814a the sensor capture range, the exposure of the first image sensor 810a ceases. The camera system is configured such that as the first image sensor 810a exits 814a the sensor capture range, the second image sensor 810b enters the sensor capture range and begins a rolling exposure 812b. Subsequently, the second image sensor exits the sensor capture range and ceases exposure 814b. The second, third, and fourth image sensors of the rotating camera array are similarly configured such that as the preceding image sensor (first, second, and third, respectively) exits the sensor capture range, the subsequent image sensor enters the sensor capture range and begins a rolling exposure.

After the fourth image sensor 810d completes a rolling exposure and exits 814d the sensor capture range the fifth image sensor enters the sensor capture range and begins 812e a rolling exposure. The image sensors of this system are rotating on the inner support structure and as time passes, the image sensors will continuously reenter the sensor capture range. In this embodiment, when the fifth image sensor 810e has completed its rolling exposure by rotating through and exiting the sensor capture range 814e, the first image sensor 810a again enters the sensor capture range and begins a rolling exposure 832a.

While the second image sensor 810b is rotating through the sensor capture range, the first image sensor 810a reads 816a first image from the first image sensor and refreshes 818a the first image sensor. Any time after the first image sensor 810a reads 816a the first image from the first image sensor 810a may output 820a the image as a first frame of an output video stream. Similarly, while the third image sensor 810c is rotating through the first sensor capture range, the second image sensor 810b reads 816b the second image from the second image sensor 816b and refreshes 818b the image sensor. Any time after the second image sensor 810b reads 816b the second image, from the second image sensor 810b may output 820b the second image as a second frame of an output video stream.

This process is similar for the third, fourth and fifth image sensors. That is, as the currently capturing image sensor 810 rotates through the sensor capture range, the preceding image sensors may read 816 the image, refresh 818 the image sensor, and output 820 the image. The first image sensor 810a again enters the sensor capture range and completes a rolling exposure as it passes through the sensor capture range. During this time, the fifth image sensor 810e will be reading 816e and refreshing 818e the fifth image from the fifth image sensor and outputting 820e the image as a fifth frame of an output video stream. The first image sensor 810a will, after some time, output an image for the output video stream for the second time 840a. The generation of the first, second, third, fourth, fifth, sixth, etc. output frames generate video stream with a framerate higher than the framerate of any single image sensor of the camera array.

Generally, FIG. 8 represents a timing diagram for a rotating camera array rotates about the rotation axis. The processes of the timing diagram can be broadly described as entering the capture range 812/832, rolling the exposure until exiting capture range 814/834, reading 816/836 the image, refreshing 818/838 the image sensor, and outputting a camera image as a video frame. One skilled in the art will note that the camera system is not limited to five image sensors and may contain any number of image sensors. Further, the indicative timings illustrated of the embodiment pictured in FIG. 8 are representative of the rotating elements of a camera system 100 and may be any range of timings that allow the described configurations or their variants, i.e. longer refresh times, greater delay between subsequent initiations of rolling exposures, etc.

### Alternative Configurations

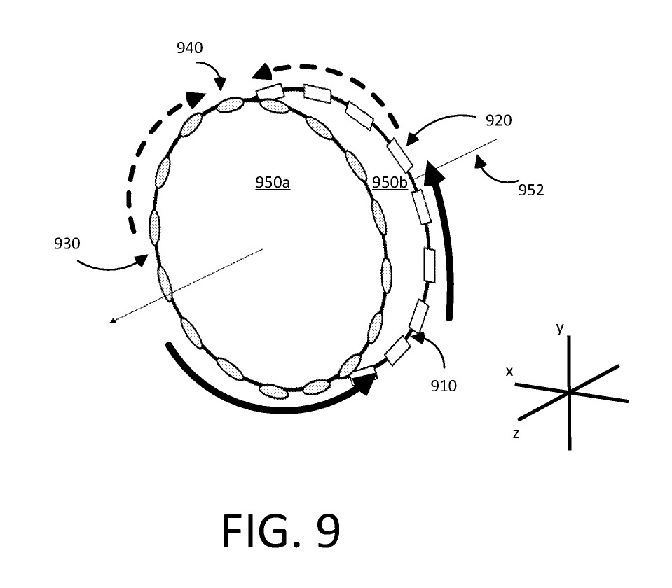

FIG. 9 shows an alternate configuration to the rotating internal elements of a camera 900 with the housing and main imaging lens not pictured, according to one embodiment. The inner support structure 910 coupled to the image sensor assemblies 920 and the outer support structure 930 coupled to the relay lenses 940 lie on two parallel planes 950 (xy plane in the illustrated embodiment) of similar diameter that are perpendicular to and rotate about the rotation axis 952 (z axis in the illustrated embodiment). The plane of the relay lenses lies closer to the front of the camera housing than the plane of the image sensor assemblies (e.g. the relay lenses are ‘in front’ of the image sensor assemblies in the illustrated embodiment). In this configuration the image plane is parallel to the plane of the image sensor assemblies. The capture axis is parallel to the z axis and perpendicular to the image plane. The inner support structure and outer support structure may both rotate in a clockwise direction through the lens capture range and sensor capture range. Alternatively the inner support structure may rotate in a clockwise direction while the outer support structure may rotate in a counter-clockwise direction through the lens capture range and sensor capture range (or vice versa). The movable joints coupling the assemblies to the rings may be configured to improve the quality of the images captured during camera rotation.

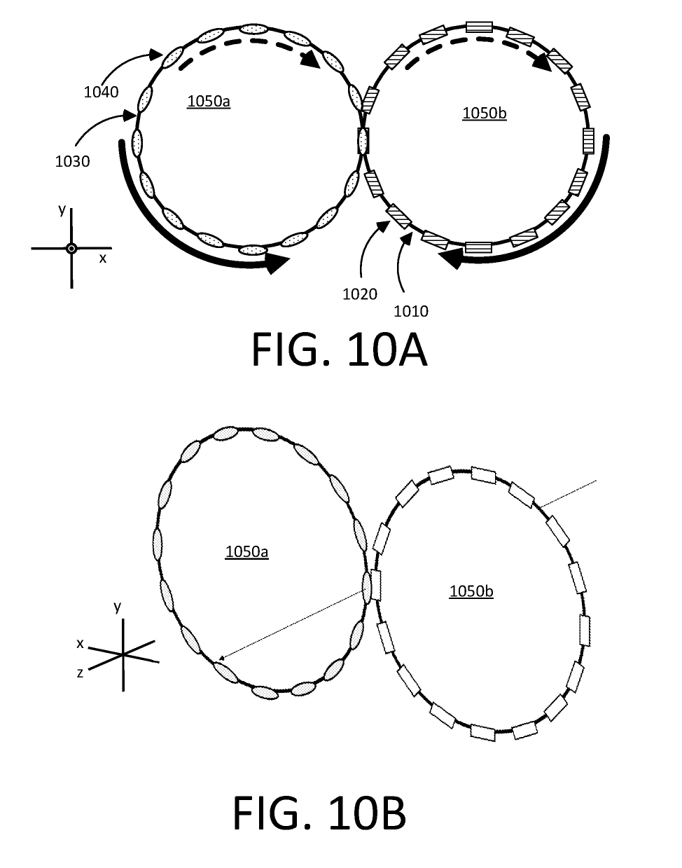

FIG. 10A-10B show an alternate configuration to the internal elements of a camera array with the housing and main imaging lens not pictured, according to one embodiment. The inner support structure 1010 coupled to the image sensor assemblies 1020 and the outer support 1030 structure coupled to the relay lenses 1040 lie on two parallel planes 1050 of similar diameter (x-y plane in the illustrated embodiment). The inner support structure rotates about a first rotation axis and the outer support structure rotates about a second rotation axis, both axes parallel to the planes of their respective support structure (z axis in the illustrated embodiment). The plane of the relay lenses lies closer to the front of the camera housing than the plane of the image sensor assemblies (e.g. the relay lenses are ‘in front’ of the image sensor assemblies in the illustrated embodiment). In this configuration the image plane is parallel to the plane of the image sensor assemblies. The capture axis is parallel to the z axis and perpendicular to the image plane. The inner support structure and outer support structure may both rotate in a clockwise direction through the lens capture range and sensor capture range. Alternatively the inner support structure may rotate in a clockwise direction while the outer support structure may rotate in a counter-clockwise direction through the lens capture range and sensor capture range (or vice versa). The movable joints coupling the assemblies to the rings may be configured to improve the quality of the images captured during camera rotation.

In one configuration, the radius of the outer support structure and the inner support structure may approach zero. That is the outer support structure and the inner support structure can become effectively linear across short ranges. In these configurations, the camera array may rotate (or translate in this instance) an effectively linear row of relay lenses through a linear lens capture range and an effectively linear row of image sensor assemblies through a sensor capture range.

### System Design Considerations

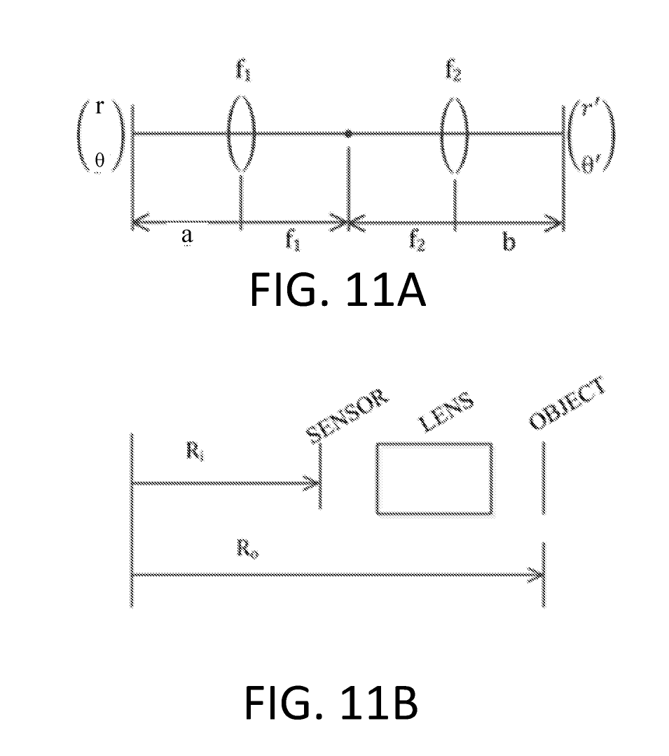

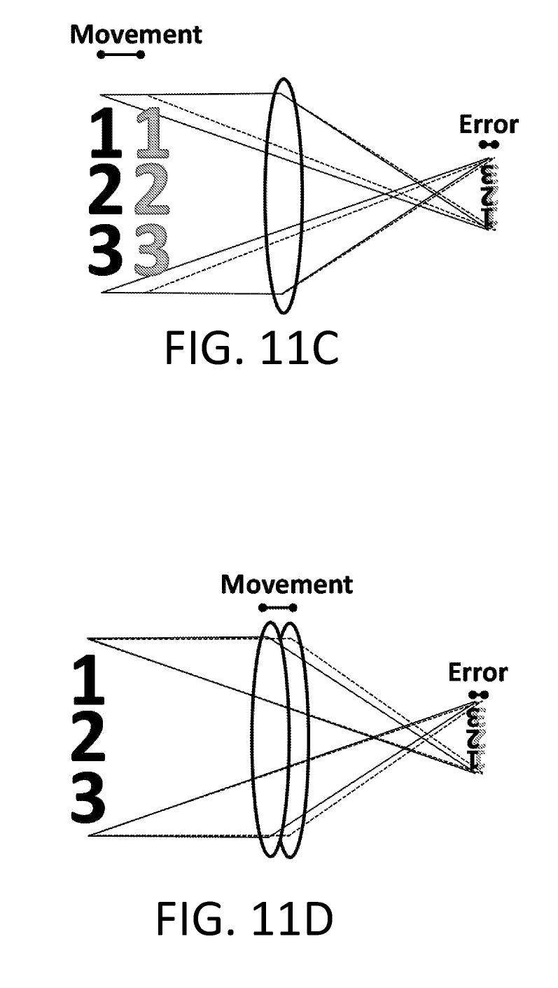

In one example configuration, the camera 100 with rotating camera elements is configured to minimize focus asymmetry. Additionally, the camera 100 can be configured to minimize the amount of image shift across the image sensor as the relay lenses and image sensor assemblies rotate through the lens capture range and the sensor capture range. To begin the description of these effects the classic ABCD matrix for the relay lens is present in FIG. 11A.

Which can be described with

$$( \begin{matrix}{r}^{′} \\ {θ}^{′}\end{matrix} ) = ( \begin{matrix}1 & b \\ 0 & 1\end{matrix} ) ( \begin{matrix}1 & 0 \\ - \frac{1}{{f}_{2}} & 1\end{matrix} ) ( \begin{matrix}1 & ( {f}_{1} + {f}_{2} ) \\ 0 & 1\end{matrix} ) ( \begin{matrix}1 & 0 \\ - \frac{1}{{f}_{1}} & 1\end{matrix} ) ( \begin{matrix}1 & a \\ 0 & 1\end{matrix} ) ( \begin{matrix}r \\ θ\end{matrix} ) \qquad ( 1 )$$

where b is the distance between the output image and the second lens, f₂ is the focal length of the second lens, f₁ is the focal length of the first lens, and a is the distance between the input image and the first lens, θ is the input ray angle, θ′ is the output ray angle, r is the input image height, and r′ is the output image height. Resulting in

$$\begin{matrix}{r}^{′} = - r \frac{{f}_{2}}{{f}_{1}} + θ ( {f}_{1} + {f}_{2} - a \frac{{f}_{2}}{{f}_{1}} - b \frac{{f}_{1}}{{f}_{2}} ) & ( 2 ) \\ {θ}^{′} = - θ \frac{{f}_{1}}{{f}_{2}} & ( 3 )\end{matrix}$$

In ideal conditions, the output image point height, r′, will have no dependence on the input ray angle θ resulting in the ideal focus condition:

$${f}_{1} + {f}_{2} - a \frac{{f}_{2}}{{f}_{1}} - b \frac{{f}_{1}}{{f}_{2}} = 0 \qquad ( 4 )$$

Using the ideal focus condition

If f₁=f₂=f then (5)

a+b=2f (6)

Within the described imaging system, the relay lens can move and the image will stay in focus as long as the object does not move and a+b=2f.

FIG. 11B illustrates an example configuration of the sensors, lenses, and objects in the rotating camera array about the inner support structure and outer support structure. The distance from the rotation axis to the image sensor is R and the distance from the rotation axis to the object to capture with the lens elements is Rₒ away from the rotation axis. Given the conditions

$$\begin{matrix}\frac{{f}_{2}}{{f}_{1}} = \frac{{R}_{i}}{{R}_{o}} & ( 7 ) \\ a = {f}_{1} & ( 8 ) \\ b = {f}_{2} & ( 9 ) \\ Then {R}_{o} = {R}_{i} + 2 f , + 2 {f}_{2} & ( 10 )\end{matrix}$$

Resulting in the optimal condition for the rotating camera array for the ratio between the outer support structure and inner support structure radii:

$$\frac{{R}_{o}}{{R}_{i}} = \frac{{R}_{i} + 2 {f}_{2}}{{R}_{i} - 2 {f}_{2}} \qquad ( 11 )$$

To continue, we describe perturbation of elements (and, in some cases, subsequent images and objects) of the rotating camera array as the camera array captures images and the error that those perturbations can cause in the relayed image. FIG. 11C illustrates a focus error caused by movement of one of the imaged objects (either the intermediate object or the input object) in the system. FIG. 1 ID illustrates focus error caused by movement of optical elements (either the main lens 300 or the relay lens 340). The movement perturbation can be longitudinal (along the imaging axis) or translational (along the image planes). These images are meant as a general representation intended to signify that even though distances between elements, objects, and images within the rotating camera array are changing while the camera array rotates, the error in the relayed image are smaller than the changes themselves. Thus, the rotating camera array maintains focus when in the optimal condition described above. Specific examples and combinations of errors caused by these perturbations are described below.

In some embodiments, error may be introduced to image capture when rotating lens elements shift from their optimal position by a distance e within the camera as they rotate. Determining the focus error, E, is from the shift e follows as

$${f}_{1} + {f}_{2} = ( a + e ) \frac{{f}_{2}}{{f}_{1}} + {b}^{′} \frac{{f}_{1}}{{f}_{2}} -> {b}^{′} = \frac{{f}_{2}}{{f}_{1}} ( {f}_{1} + {f}_{2} - [ a + e ] \frac{{f}_{2}}{{f}_{1}} ) \qquad ( 12 )$$

This may differ from an optimal case in which

$${f}_{1} + {f}_{2} = ( a + e ) \frac{{f}_{2}}{{f}_{1}} + ( b - e ) \frac{{f}_{1}}{{f}_{2}} \qquad ( 13 )$$

Therefore the focus error E is

$${b}^{′} - ( b - e ) = ɛ = \frac{{f}_{2}}{{f}_{1}} ( {f}_{1} + {f}_{2} - [ a + e ] \frac{{f}_{2}}{{f}_{1}} ) - ( b - e ) \qquad ( 14 )$$

and using

$$b = a \frac{{f}_{2}}{{f}_{1}} \qquad ( 15 )$$

the absolute focus error from lens shift becomes

$$ɛ = e ( 1 - \frac{{f}_{2}^{2}}{{f}_{1}^{2}} ) \qquad ( 16 )$$

Using the relation between the focal lengths and rotation ring radii

$$\frac{{f}_{2}}{{f}_{1}} = \frac{{R}_{i}}{{R}_{o}} \qquad ( 17 )$$

the absolute focus error from a shifting lens c becomes

$$ɛ = e ( 1 - \frac{{R}_{i}^{2}}{{R}_{o}^{2}} ) \qquad ( 18 )$$

From which we can determine the absolute focus error from lens shifts within the system can be minimized by having large Rᵢ and Rₒ.

Another source of focus error, δ, can occur when the input object shifts by a distance d and there is also a sensor shift by d·f₂/f₁. Under these conditions

$${b}^{′} = {f}_{2} + \frac{{f}_{2}^{2}}{{f}_{1}} - ( a + d ) \frac{{f}_{2}^{2}}{{f}_{1}^{2}} \qquad ( 19 )$$

However, the image shift does track the lens magnification and thus b′ is compared with b−d·f₂ /f₁. Thus, for

$$b = {f}_{2} + \frac{{f}_{2}^{2}}{{f}_{1}} - a \frac{{f}_{2}^{2}}{{f}_{1}^{2}} \qquad ( 20 )$$

and from the focus conditions

$$\begin{matrix}δ = {b}^{′} - ( b - d \frac{{f}_{2}}{{f}_{1}} ) & ( 21 ) \\ δ = {f}_{2} + \frac{{f}_{2}^{2}}{{f}_{1}} - ( a + d ) \frac{{f}_{2}^{2}}{{f}_{1}^{2}} - {f}_{2} - \frac{{f}_{2}^{2}}{{f}_{1}} + a \frac{{f}_{2}^{2}}{{f}_{1}^{2}} + d \frac{{f}_{2}}{{f}_{1}} & ( 22 )\end{matrix}$$

The absolute focus error due to object shift of d and image sensor shift of d·f₂/f₁, δ, is

$$δ = d ( \frac{{f}_{2}}{{f}_{1}} - \frac{{f}_{2}^{2}}{{f}_{1}^{2}} ) \qquad ( 23 )$$

To minimize the error δ the system should be configured with f₂ and f₁ as close in value as possible. The input object shift d is dependent on the input height variation (IHᵥ) of the object as the elements rotate. This is represented by the relation:

$$d = \frac{{{f}_{1} ( {IH}_{v} )}^{2}}{{f}_{2} \cdot {R}_{i}} \qquad ( 24 )$$

Therefore, several design configurations may be considered to minimize detrimental effects within the camera 100: a large the radius of the inner support structure, Rᵢ and a large the radius of the outer support structure, Rₒ, a short focal length of the relay lenses and the main imaging lens, the focal length of the relay lenses, f₁, and the focal length of the main imaging lens, f₂, being approximately equal, a total magnification of the lens assemblies and main imaging lens approaching −1, a system including N image sensor assemblies on the inner support structure has 2N relay lenses on the outer support structure, the angular velocity of the inner support structure is twice the angular velocity of the outer support structure as the support structures rotate about the rotation axis.

By way of example, a camera array with rotating elements capturing 4 k resolution images with a pixel pitch of 1.55 μm, f₂ of 10 mm, Rᵢ of 100 mm, an individual sensor framerate of 60 fps, and 16 image sensors. Using the derived conditions above, the ideal outer radius Rₒ is

$${R}_{o} = \frac{{R}_{i} + 2 {f}_{2}}{1 - {2}^{\frac{{f}_{2}}{{R}_{i}}}} = 150 mm \qquad ( 25 )$$

The ideal focal length f₁ is

$${f}_{1} = {f}_{2} \frac{{R}_{o}}{{R}_{i}} = 15 mm \qquad ( 26 )$$

If the input object moves across half of the image sensor during rotation, the input height variation (IHᵥ) across the image sensor is

IHᵥ=½(2160)(1.55 μm)=1.67 mm (27)

This may provide an input object shift d of

$$d = \frac{{{f}_{1} ( {IH}_{v} )}^{2}}{{f}_{2} \cdot {R}_{i}} = 42 µm \qquad ( 28 )$$

and an error due to that shift δ of

$$δ = d ( \frac{{f}_{2}}{{f}_{1}} - \frac{{f}_{2}^{2}}{{f}_{1}^{2}} ) = 9.3 µm \qquad ( 29 )$$

or approximately 3-4 pixels.

The total framerate (F) of the system 960 fps (60 fps·16 cameras). With this framerate the tangential velocity of an individual lens element is

Vₒ=2πRₒ·(½F)=28.3 m/s (30)

and the tangential velocity of an individual sensor is

Vₛ=2πRᵢF=37.7 m/s (31)

### Additional Configuration Considerations

The disclosed embodiments have several benefits and advantages. For example, the rotating array allows for an increase in total framerate of the camera system relative to the framerates of the individual image sensors. In another example, the rotating array can use any number of low quality image sensors to achieve framerates of higher quality and more expensive image sensors. In yet another example, the rotating camera array allows a full exposure of the image sensor whereas typical high framerate cameras truncates exposure times to increase framerates (often resulting in dim images).

Throughout this specification, some embodiments have used the expression “coupled” along with its derivatives. The term “coupled” as used herein is not necessarily limited to two or more elements being in direct physical or electrical contact. Rather, the term “coupled” may also encompass two or more elements are not in direct contact with each other, but yet still co-operate or interact with each other, or are structured to provide a thermal conduction path between the elements.

Likewise, as used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Upon reading this disclosure, those of skill in the art will appreciate still additional alternative structural and functional designs for a heat spreader as disclosed from the principles herein. Thus, while particular embodiments and applications have been illustrated and described, it is to be understood that the disclosed embodiments are not limited to the precise construction and components disclosed herein. Various modifications, changes and variations, which will be apparent to those, skilled in the art, may be made in the arrangement, operation and details of the method and apparatus disclosed herein without departing from the spirit and scope defined in the appended claims.

What is claimed is:

1. A camera system comprising:
a housing comprising:
an inner support structure comprising a first circle having a first radius and a first rotational axis about a center point of the inner support structure, the first rotational axis structured to allow the inner support structure to rotate at an inner angular velocity, and
an outer support structure internal to the housing, the outer support structure comprising a second circle having a second radius and a second rotational axis about a center point of the outer support structure, the second rotational axis structured to allow the inner support structure to rotate at an outer angular velocity;
an outer lens assembly coupled to an exterior of the camera system, the outer lens assembly comprising at least one lens element for focusing light into the housing along a capture axis;
a plurality of image sensor assemblies internal to the housing and coupled to the inner support structure, each image sensor assembly comprising an image sensor configured to detect and capture images from light focused into the housing; and
a plurality of lens assemblies coupled to the outer support structure configured to focus light into the housing via the outer lens assembly onto the plurality of the image sensor assemblies to capture images as the plurality of lens assemblies and the plurality of image sensor assemblies rotate about the first rotational axis and the second rotational axis.

2. The camera system of claim 1, wherein a first image sensor assembly of the plurality of image sensor assemblies enters a sensor capture range as the first image sensor assembly approaches the capture axis, the sensor capture range comprising a first arc of the first circle that the inner support structure passes through as it rotates about the first rotational axis.

3. The camera system of claim 2, wherein a first lens assembly of the plurality of lens assemblies enters a lens capture range as the first lens assembly approaches the capture axis, the lens capture range comprising a second arc of the second circle that the outer support structure passes through as it rotates about the second rotational axis.

4. The camera system of claim 3, wherein a first lens element focuses light onto the image sensor of the first lens assembly and captures an image as the first lens assembly rotates through the sensor capture range and the first lens element rotates through lens capture range.

5. The camera system of claim 4, wherein a second image sensor assembly of the plurality of image sensor assemblies and a second lens assembly of the plurality of lens assemblies enters the lens capture range and the sensor capture range after the first image sensor assembly and first lens assembly rotate past the lens capture range and the sensor capture range, wherein the second lens assembly focuses light onto the second image sensor assembly for image capture.

6. The camera system of claim 1, further comprising:
a processor configured to interlace captured images from the plurality of image sensor assemblies into an image sequence and output the image sequence as a video stream.

7. The camera system of claim 1, wherein the first rotational axis and the second rotational axis are a same axis.

8. The camera system of claim 1, wherein a number of the plurality of lens assemblies is twice a number of the plurality of image sensor assemblies.

9. The camera system of claim 1, wherein the plurality of image sensor assemblies are coupled to the outer support structure by a movable joint and the plurality of lens assemblies are coupled to the inner support structure by a movable joint.

10. A method for generating a video stream from a rotating array of image sensor assemblies and lens assemblies of a camera system, the method comprising:
capturing a first image using a first image sensor assembly as the first image sensor assembly enters a sensor capture range;
capturing a second image using a second image sensor assembly as the second image sensor assembly enters the sensor capture range after the first image sensor assembly rotates past the sensor capture range; and
rotating the first and second image sensor assemblies through the sensor capture range such that a plurality of images are captured by the first and second image sensor assemblies.

11. The method of claim 10, further comprising:
generating the video stream from the plurality of images.

12. The method of claim 10, wherein the sensor capture range comprises a first arc of a first circle that an inner support structure of the camera system passes through as it rotates about a first rotational axis.

13. The method of claim 12, further comprising:
rotating a first lens assembly through a lens capture range, the lens capture range comprising a second arc of a second circle that an outer support structure of the camera system passes through as it rotates about a second rotational axis.

14. The method of claim 13, wherein the first rotational axis and the second rotational axis are a same axis.

15. The method of claim 14, further comprising:
rotating a second lens assembly through the lens capture range after the first lens assembly rotates past the lens capture range.

16. The method of claim 13, further comprising:
accelerating the outer support structure to an outer angular velocity and the inner support structure to an inner angular velocity.

17. A computer program product for capturing images from a rotating camera array, the computer program product comprising a non-transitory machine-readable medium storing computer program code, the computer program code when executed causes at least one processor to:
capture a first image using a first image sensor assembly of a plurality of image sensor assemblies as the first image sensor assembly enters a sensor capture range, the sensor capture range comprising a first arc of a first circle that an inner support structure passes through as it rotates about a first rotational axis;
capture a second image using a second image sensor assembly of the plurality of image sensor assemblies as the second image sensor assembly enters the sensor capture range after the first image sensor assembly rotates past the sensor capture range; and
rotate the plurality of image sensor assemblies through the sensor capture range such that a plurality of images are captured by the plurality of image sensor assemblies.

18. The computer program product of claim 17, wherein executing the computer program code further causes at least one processor to rotate a first lens assembly of a plurality of lens assemblies through a lens capture range, the lens capture range comprising a second arc of a second circle that an outer support structure passes through as it rotates about a second rotational axis.

19. The computer program product of claim 18, wherein executing the computer program code further causes at least one processor to rotate a second lens assembly of the plurality of lens assemblies through the lens capture range after the first lens assembly rotates past the lens capture range.

20. The computer program product of claim 18, wherein the first rotational axis and the second rotational axis are a same axis.
